(19) United States
(12) Patent Application Publication
(10) Pub. No.: US 2017/0232926 A1
(43) Pub. Date: Aug. 17, 2017

(54) VEHICLE HOOD ASSEMBLY WITH DEPLOYABLE PEDESTRIAN PROTECTION

(71) Applicant: Ford Global Technologies, LLC, Dearborn, MI (US)

(72) Inventors: Saeed David Barbat, Novi, MI (US); Dean M. Jaradi, Macomb, MI (US); S.M. Iskander Farooq, Novi, MI (US); Mohammed Omar Faruque, Ann Arbor, MI (US)

(73) Assignee: Ford Global Technologies, LLC, Dearborn, MI (US)

(21) Appl. No.: 15/042,164

(22) Filed: Feb. 12, 2016

(51) Int. Cl. B60R 21/38

(52) U.S. Cl. CPC B60R 21/38

(57) ABSTRACT

A hood assembly for a vehicle includes an inner hood, an outer hood, and a deployable device. The outer hood is fixed relative to the inner hood and defines a gap between the inner hood and the outer hood. The deployable device is disposed in the gap. The deployable device defines an inflation chamber and is formed of thermoplastic elastomer. Upon detection of impact between the vehicle and a pedestrian, the deployable device is deployed to separate the outer hood and the inner hood. As such, during impact of the pedestrian with the outer hood, the outer hood may deform and/or the outer hood may space the pedestrian from relatively hard components under the hood assembly.

### BACKGROUND

A hood assembly of a vehicle may be designed to be low profile, e.g., a relatively low hood height, which may allow for a desired styling. However, such a design may bring panels of the hood assembly closer to relative hard points under the hood assembly, e.g., an engine. Thus, the “crush space” between the hood and underlying hard points is reduced. A desire for a low profile design for a hood assembly may be in tension with design factors that favor increased “crush space” to reduce the likelihood of head impact injuries to pedestrians involved pedestrian-vehicle impacts. Specifically, the increased “crush space” spaces the pedestrian from the relative hard points under the hood assembly and/or allows for greater hood deformation, which absorbs energy from and reduces the impact velocity of the pedestrian.

Therefore, there remains an opportunity to design an improved design to allow low-profile hood assembly styling while accommodating design factors to reduce the likelihood of injury to pedestrians during pedestrian-vehicle impacts.

### BRIEF DESCRIPTION OF THE DRAWINGS

FIG. 1 is a perspective view of a vehicle including a hood assembly.

FIG. 2 is a perspective view of the vehicle with a deployable device of the hood assembly in a deployed position.

FIG. 3 is a partially exploded view of the hood assembly with an upper hood exploded away from an inner hood to illustrate the deployable device therebetween, with the deployable device in an undeployed position.

FIG. 4 is the partially exploded view of the hood assembly of FIG. 3 with the deployable device in the deployed position.

FIG. 5 is a cross-sectional view of the hood assembly with the deployable device in the undeployed position.

FIG. 6 is a cross-sectional view of the hood assembly with the deployable device in the deployed position.

FIG. 7 is a schematic of a control system.

### DETAILED DESCRIPTION

With reference to the Figures, wherein like numerals indicate like parts throughout the several views, a hood assembly 40 for a vehicle 30 includes an inner hood 42, an outer hood 44, and a deployable device 70. The outer hood 44 is fixed relative to the inner hood 42 and defines a gap 52 between the inner hood 42 and the outer hood 44. The deployable device 70 is disposed in the gap 52. The deployable device 70 defines an inflation chamber 78 and is formed of thermoplastic elastomer.

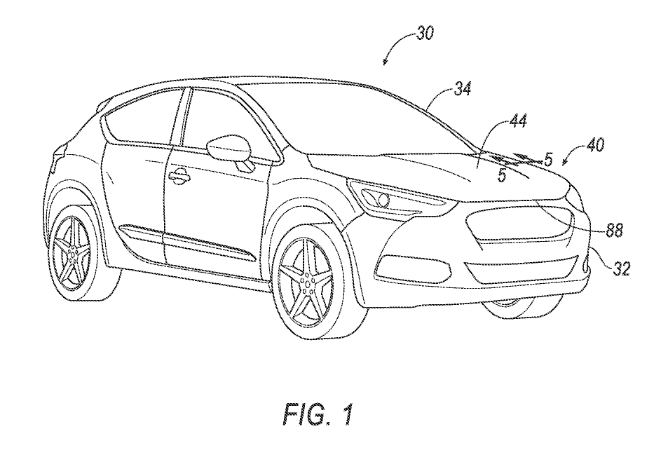

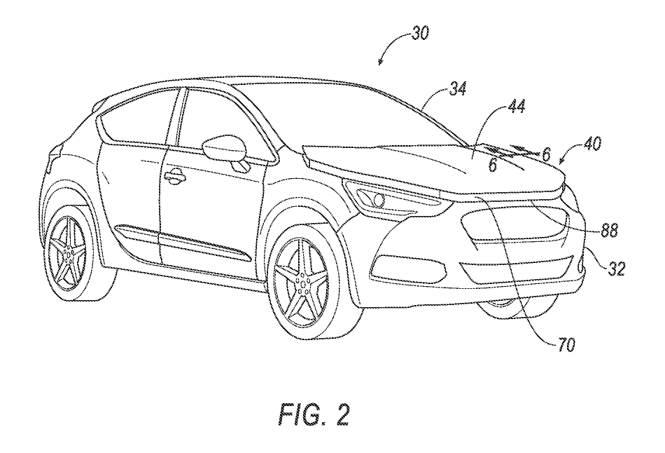

The deployable device 70 may be deployed from an undeployed position, as shown in FIGS. 1, 3, and 5, to a deployed position, as shown in FIGS. 2, 4, and 6, to move the inner hood 42 and the outer hood 44 relative to each other. As shown in FIGS. 2 and 6, in the deployed position the deployable device 70 selectively increases the space between the outer hood 44 and relatively hard components under the hood assembly, e.g., an engine (not shown), during a collision between the vehicle 30 and the pedestrian. The increased space may reduce the likelihood of injury to pedestrians, e.g., head injuries. At the same time, since the deployable device 70 is disposed between the inner hood 42 and the outer hood 44, the vehicle hood assembly 40 may have a low-profile design.

With reference to FIGS. 1 and 2, the vehicle 30 may include a front bumper 32 and the vehicle hood assembly 40. The hood assembly 40 is positioned forward of a windshield 34 and covers the engine. The front bumper 32 may be located below a front of the hood assembly 40 and may absorb energy in a frontal collision for the vehicle 30. The front bumper 32 may support an impact sensor 92, as discussed further below.

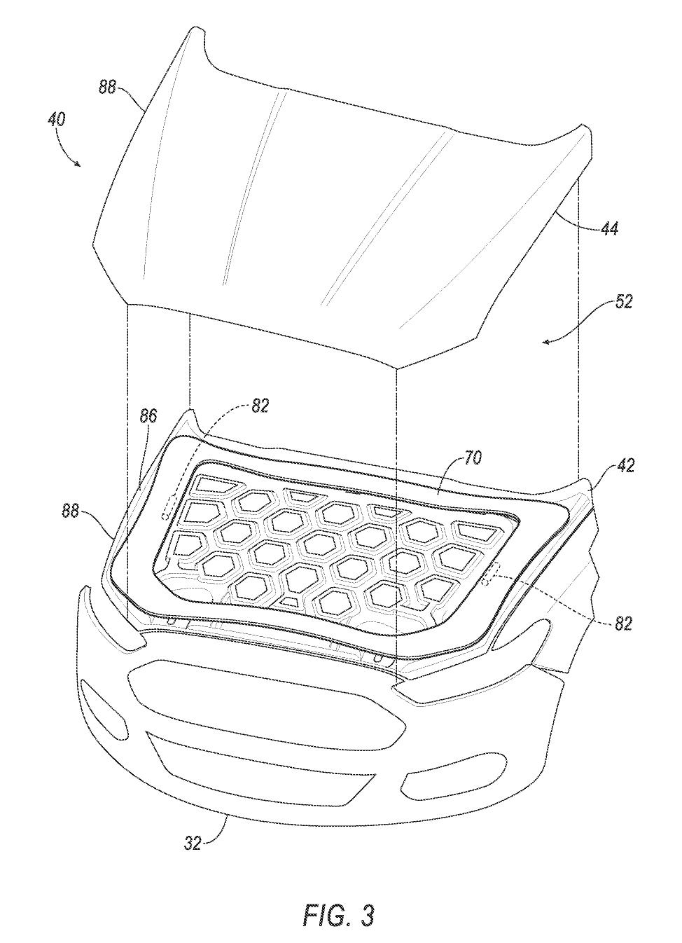

With reference to FIGS. 3-6, the outer hood 44 is disposed above the inner hood 42. As shown in the Figures the outer hood 44 is exposed when the hood assembly 40 is in a closed position. The outer hood 44 may present a class-A surface, e.g., a finished surface exposed to view by a customer and free of unaesthetic blemishes and defects. The inner hood 42 and the outer hood 44 may be formed of the same type of material. The inner hood 42 and/or the outer hood 44 may, for example, be formed of plastic, for example, sheet molding composite (SMC), carbon fiber reinforced plastic (CFRP), fiberglass, and/or other fiber reinforced plastic. Alternatively, the inner hood 42 and the outer hood 44 may be formed of metal, e.g., aluminum, steel, etc.

The outer hood 44 is fixed relative to the inner hood 42, that is, the outer hood 44 is directly or indirectly attached to the inner hood 42. The outer hood 44 defines a gap 52 between the inner hood 42 and the outer hood 44. Specifically, the inner hood 42 and the outer hood 44 may each include a mounting surface 86. The mounting surfaces 86 may be bonded to each other, e.g., by application of adhesive, plastic welding, metal welding etc. Alternatively, the mounting surfaces 86 may be formed into a hem flange connecting the inner hood 42 and the outer hood 44. The mounting surfaces may 86 extend along an elongated path, which generally extends along a periphery 88 of the inner hood 42 and/or the outer hood 44.

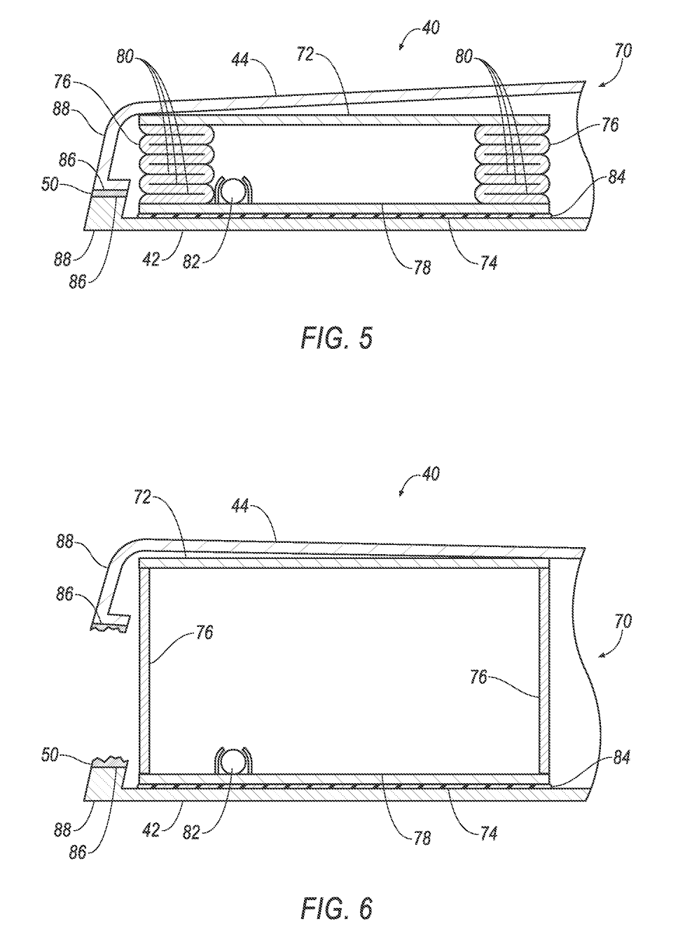

For example, with reference to FIGS. 5 and 6, an adhesive 50 may connect the inner hood 42 and the outer hood 44, e.g., at the mounting surfaces 86. The adhesive 50 may extend along the elongated path along the periphery 88 of the inner hood 42 and/or the outer hood 44. The adhesive 50 may be formed of any suitable compound.

The adhesive 50 may be frangible relative to the inner hood 42 and the outer hood 44, that is, the adhesive 50 may be designed to break when the deployable device 70 inflates. The force required to break the adhesive 50 is less than the force applied by the inflating deployable device 70 and may be less than the force to deform either the inner hood 42 or the outer hood 44.

The hood assembly 40 may be attached to a frame (not numbered) of the vehicle 30 at a hinge (not shown). The hinge may be fixed to the inner hood 42 and/or to the outer hood 44. The inner hood 42, the outer hood 44, and the deployable device 70 move together as a unit about the hinge, e.g., to access the engine of the vehicle 30. A latch (not shown) may selectively fix the hood assembly 40 in a closed position relative to the body of the vehicle.

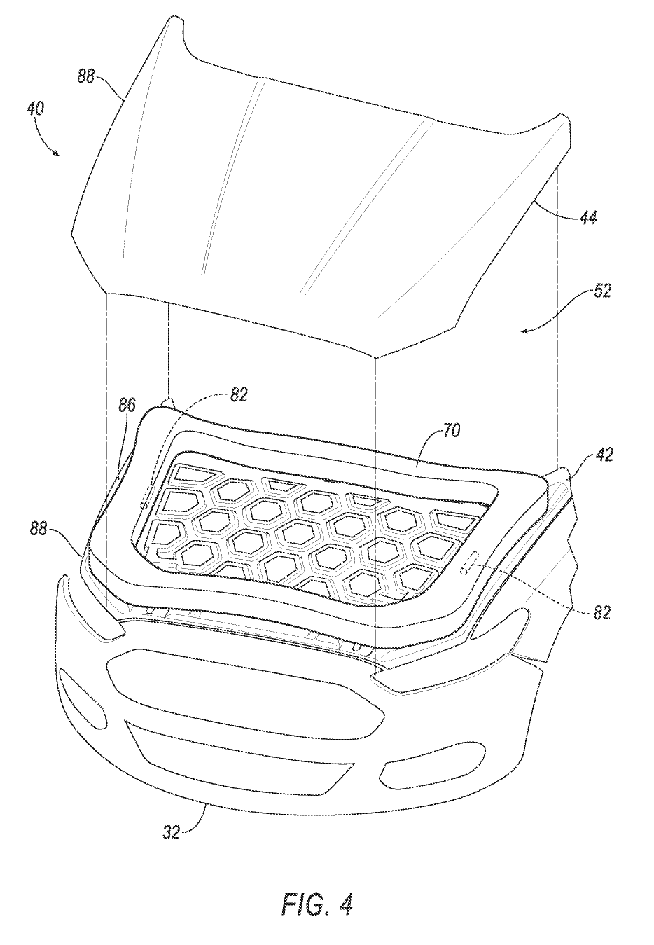

With reference to FIGS. 3 and 4, the deployable device 70 may have a shape that follows the periphery 88 of the inner hood 42 and/or the outer hood 44. For example, the deployable device 70 may have an annular shape, i.e., a ring shape. Said differently, the annular shape extends about a void, and may be rectangular (as shown in FIGS. 3-4), round, elliptical, or any polygonal shape.

With reference to FIGS. 5 and 6, the deployable device 70 may include a top panel 72, a bottom panel 74, and sides 76 connecting the top panel 72 and the bottom panel 74. The deployable device 70 defines an inflation chamber 78; specifically, the sides 76 define the inflation chamber 78 therebetween. The inflation chamber 78 is enclosed by the top panel 72, the bottom panel 74, and the sides 76. The deployable device 70 may have vents (not shown) extending from the inflation chamber 78 through the top panel 72, the bottom panel 74, and/or the sides 76 to allow the deployable device 70 to vent, e.g., to allow the deployable device 70 to deflate and soften upon impact between the hood assembly 40 and a pedestrian. The deployable device 70 may have a constant cross-sectional shape around the annular shape, or alternatively, may vary in cross-sectional shape around the annular shape.

The top panel 72, the bottom panel 74, and the sides 76 may be molded. In other words, the top panel 72, the bottom panel 74, and the sides 76 may be formed from a molding process in which a liquid or pliable material is molded under pressure in a mold, e.g., injection molding, blow molding, extrusion molding, etc.

The top panel 72 and the bottom panel 74 are each from 1 to 3 millimeters thick. The top panel 72 and the bottom panel 74 may have the same thickness, or may have different thicknesses. The top panel 72 and/or the bottom panel 74 may be thicker than the sides 76.

The sides 76 may define pleats 80 between the top panel 72 and the bottom panel 74. The pleats 80 are folded when the deployable device 70 is in the undeployed position, and the pleats 80 are extended when the deployable device 70 is in a deployed position. The pleats 80 may be arranged in an accordion-like fashion or may be folded in any other suitable manner.

The deployable device 70 is formed of thermoplastic elastomer (TPE). A thermoplastic elastomer has both thermoplastic and elastomeric properties. A thermoplastic material becomes pliable above a particular temperature and solidifies upon cooling, and an elastomer generally has a low Young's modulus and a high failure strain. Types of TPEs include styrenic block copolymers, thermoplastic olefins, elastomeric alloys, thermoplastic polyurethanes, thermoplastic copolyesters, and thermoplastic polyamides. The material forming the deployable device 70 is solid, not woven like a fabric.

The deployable device 70 is fixed, e.g., bonded, to the inner hood 42 (as shown in FIGS. 5 and 6) and/or the outer hood 44. For example, the deployable device 70 may be fixed to the inner hood 42 with adhesive 84, as shown in FIGS. 5 and 6. Alternatively, or in addition, the deployable device 70 may be fixed to the inner hood 42 and/or the outer hood 44 by welding, such as ultrasonic welding, fasteners, etc.

The hood assembly 40 may include an inflator 82 is in communication with the inflation chamber 78 of the deployable device 70. The inflator 82 inflates the deployable device 70 with an inflatable medium, such as a gas.

The inflator 82 may be located inside or outside the deployable device 70. The inflator 82 may be fixed to the deployable device 70 or may be remote from the deployable device 70 and in communication with the inflation chamber 78, e.g., through a fill tube. As one example, as shown in FIGS. 5 and 6, the deployable device 70 may define at least one clip (not numbered) in the inflation chamber 78 that fixes the inflator 82 to the deployable device 70. The clip may be of any suitable size and shape to fix the inflator 82 to the deployable device 70. The clip, for example, may be integral with the top panel 72, bottom panel 74 (as shown in FIGS. 5 and 6), and/or sides 76, i.e., formed simultaneously with the panel 72, bottom panel 74, and/or sides 76 as a single continuous unit. Alternatively, the clip may be formed separately from and subsequently connected to the top panel 72, bottom panel 74, and/or sides 76.

The inflator 82 may be, for example, a pyrotechnic inflator 82 that uses a chemical reaction to drive inflation medium to the deployable device 70. The inflator 82 may be of any suitable type, for example, a cold-gas inflator.

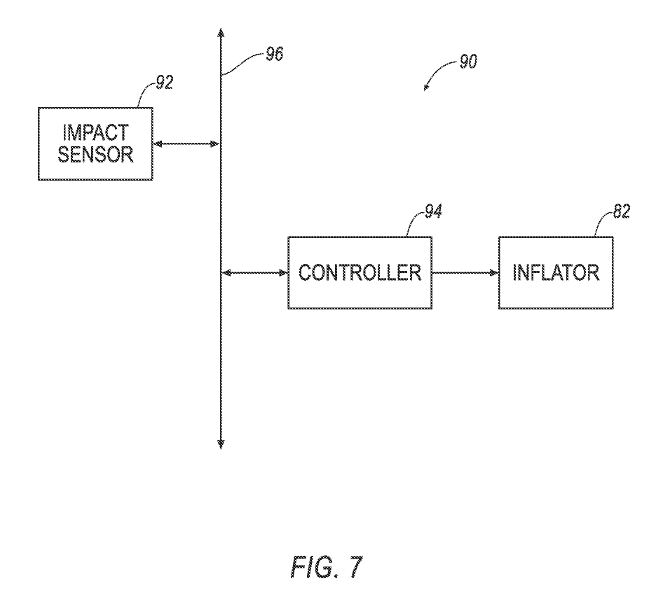

With reference to FIG. 7, the vehicle 30 may include a control system 90 including at least one impact sensor 92 for sensing an impact of the vehicle 30, and a controller 94 in communication with the sensor 92 and the inflator 82 for activating the inflator 82, for example, by providing an impulse to a pyrotechnic charge of the inflator 82, when the sensor 92 senses an impact of the vehicle 30. Alternatively or additionally to sensing impact, the control system 90 may be configured to sense an impending impact prior to the actual impact, that is, pre-impact sensing.

The impact sensor 92 is adapted to detect an impact to the front bumper 32. The impact sensor 92 may be of any suitable type, for example, using radar, lidar, or a vision system. The vision system may include one or more cameras, CCD image sensors, CMOS image sensors, etc. The sensor 92 may be included within the front bumper 32 or may be located elsewhere in the vehicle 30.

The controller 94 may be a microprocessor-based controller. The controller 94 may include a processor, memory, etc. The memory of the controller 94 may store instructions executable by the processor. The impact sensor 92 is in communication with the controller 94 to communicate data to the controller 94. The controller 94 is programmed to instruct the inflator 82 to inflate the deployable device 70 in response to a pedestrian impact sensed by the impact sensor 92.

The control system 94 may transmit signals through a communication network 96 (such as a controller area network (CAN) bus), Ethernet, and/or by any other wired or wireless communication network. The controller 94 may use information from the communication network 96 to control the activation of the inflator 82. The inflators 82 may be connected to the controller 94, as shown in FIG. 7, or may be connected directly to the communication network 96.

In the event that impact sensor 92 detects a collision with a pedestrian, the impact sensor 92 signals the controller 94 through the communication network 96. The controller 94 instructs the inflator 82 through the communication network 96 to inflate the deployable device 70. The inflator 82 inflates the deployable device 70, which changes from the undeployed position (as in FIG. 1) to the deployed position (as in FIG. 2). The deployable device 70 pushes against the outer hood 44. The adhesive 50 holding the outer hood 44 to the inner hood 42 breaks, and the deployable device 70 raises the outer hood 44, e.g., by approximately 2-3 inches. As the pedestrian impacts the outer hood 44, the outer hood 44 deforms and/or the deployable device 70 deforms to absorb energy from the impact and spaces the pedestrian from components beneath the hood assembly 40, e.g., the engine. The energy absorbed by the hood assembly 40 may reduce the likelihood of the pedestrian impacting a component under the hood assembly 40 and/or may reduce the velocity at which the pedestrian impacts such a component.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle hood assembly comprising:
an inner hood;
an outer hood fixed relative to the inner hood and defining a gap between the inner hood and the outer hood, wherein the inner hood and the outer hood are formed of plastic;
an adhesive connecting the inner hood and the outer hood; and
a deployable device disposed in the gap, the deployable device defining an inflation chamber and being formed of thermoplastic elastomer, wherein the deployable device is bonded to one of the inner hood and the outer hood.

2. (canceled)

3. The vehicle hood assembly of claim 1, wherein the adhesive extends along an elongated path and the deployable device is elongated along the elongated path of the adhesive.

4. The vehicle hood assembly of claim 3, wherein the adhesive is frangible relative to the inner hood and the outer hood.

5. The vehicle hood assembly of claim 1, wherein the deployable device includes a top panel, a bottom panel, and sides connecting the top panel and the bottom panel and defining pleats between the top panel and the bottom panel, wherein the pleats are folded when the deployable device is in an undeployed position and wherein the pleats are extended when the deployable device is in a deployed position.

6. The vehicle hood assembly of claim 1, wherein the deployable device includes a top panel, a bottom panel, and sides connecting the top panel and the bottom panel, and wherein at least one of the top panel and the bottom panel are from 1 to 3 millimeters thick.

7. The vehicle hood assembly of claim 1, wherein the deployable device has an annular shape.

8. The vehicle hood assembly of claim 1, further comprising an inflator in communication with the deployable device.

9. (canceled)

10. (canceled)

11. A vehicle hood assembly comprising:
an inner hood;
an outer hood fixed to the inner hood, wherein the inner hood and the outer hood are formed of plastic;
an adhesive connecting the inner hood and the outer hood; and
a deployable device between the outer hood and the inner hood, the deployable device including a molded top panel, a molded bottom panel, and sides connecting the molded top panel and the molded bottom panel defining an inflation chamber therebetween, wherein the deployable device is bonded to one of the inner hood and the outer hood.

12. (canceled)

13. The vehicle hood assembly of claim 12, wherein the adhesive extends along an elongated path and the deployable device is elongated along the elongated path of the adhesive.

14. The vehicle hood assembly of claim 13, wherein the adhesive is frangible relative to the inner hood and the outer hood.

15. The vehicle hood assembly of claim 11, wherein the sides define pleats between the molded top panel and the molded bottom panel, and wherein the pleats are folded when the deployable device is in an undeployed position and are extended when the deployable device is in a deployed position.

16. The vehicle hood assembly of claim 11, wherein the deployable device has an annular shape.

17. The vehicle hood assembly of claim 11, further comprising an inflator in communication with the deployable device.

18. (canceled)

19. (canceled)

20. A vehicle comprising:
an inner hood;
an outer hood fixed relative to the inner hood, wherein the inner hood and the outer hood are formed of plastic;
an adhesive connecting the inner hood and the outer hood;
a deployable device between the outer hood and the inner hood and being formed of a thermoplastic elastomer, the deployable device defining an inflation chamber, wherein the deployable device is bonded to one of the inner hood and the outer hood;
an inflator in communication with the inflation chamber;
an impact sensor; and
a controller programmed to instruct the inflator to inflate the deployable device in response to a pedestrian impact sensed by the impact sensor.
